(19) United States
(12) Patent Application Publication
(10) Pub. No.: US 2016/0222263 A1
(43) Pub. Date: Aug. 4, 2016

(54) METHOD OF FILLING AND SEALING A JOINT BETWEEN PANELS

(71) Applicant: Scott Myers, Cuba City, WI (US)

(72) Inventor: Scott Myers, Cuba City, WI (US)

(21) Appl. No.: 14/609,117

(22) Filed: Jan. 29, 2015

(51) Int. Cl. C09K 3/10; C09J 7/00; B32B 38/10; B32B 37/12; B32B 37/18

(52) U.S. Cl. CPC C09K 3/1021; B32B 37/1284; B32B 37/18; B32B 38/10; C09J 7/00; B32B 2250/03; B32B 2509/10

(57) ABSTRACT

A method of filling and sealing a joint where a cartridge containing a mixture of a first part and a second part is injected into a groove between panels, smoothed, and allowed to harden.

### BACKGROUND OF THE INVENTION

This invention is directed to a method of filling and sealing a joint and more particularly a method for filling and sealing joints in cold storage rooms.

Presently, joints between panels in cold storage rooms are filled with silicone or urethane. While useful, these materials require replacement every maintenance period and do not provide a chemical weld. Further, these materials are not safe for food. Therefore, a need exists in the art for a method that addresses these deficiencies.

An objective of the present invention is to provide a method of filling a joint that reduces the need for replacement.

Another objective of the present invention is to provide a method of filling a joint that provides a chemical weld.

A still further objective of the present invention is to provide a method of filling a joint that is safe to use with food.

These and other objectives will be apparent to those skilled in the art based upon the following written description, drawings, and claims.

### SUMMARY OF THE INVENTION

A method of filling and sealing a joint where panels having a groove there between are cleaned and dried and adhesive tape is placed on both sides of the groove. A mixture having a first part and a second part is injected into the groove and the mixture is smoothed using a grout float. Finally, the adhesive tape is removed and the mixture is allowed to harden.

### BRIEF DESCRIPTION OF THE DRAWINGS

FIG. 1 is a side view of a double cartridge and pneumatic cartridge gun;

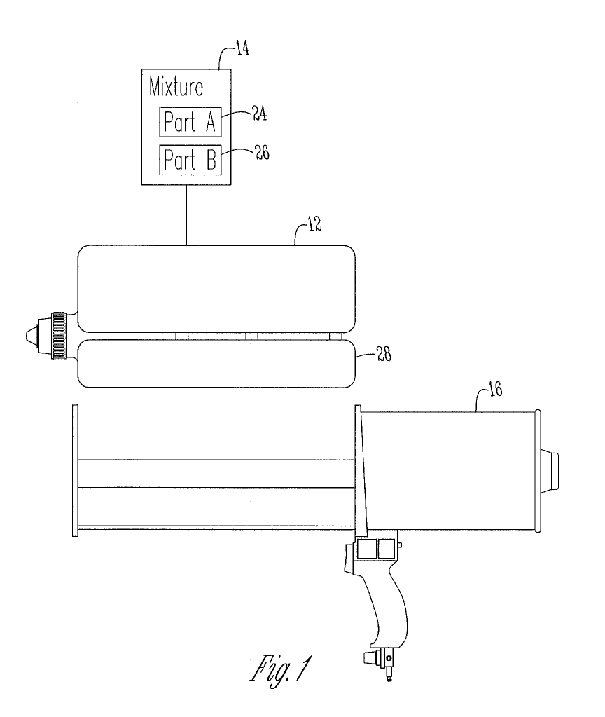

FIG. 2 is a front view of panels with mixture in a groove there between; and

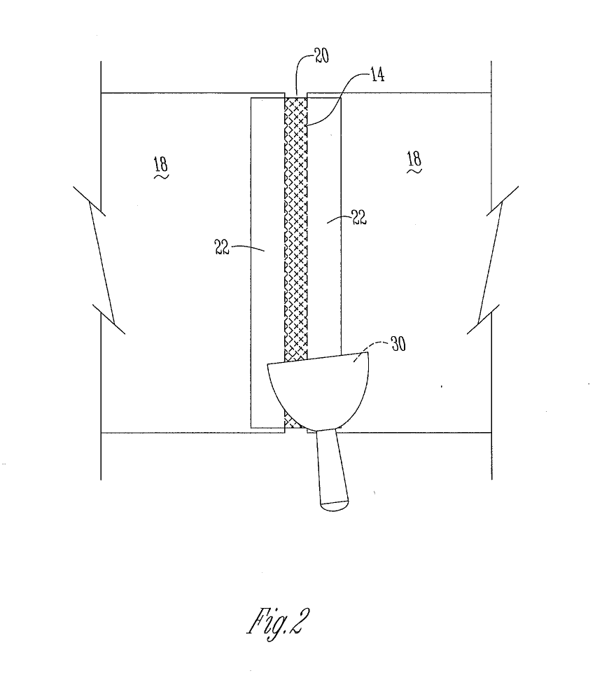

FIG. 3 is a flow diagram of a method of filling and sealing a joint.

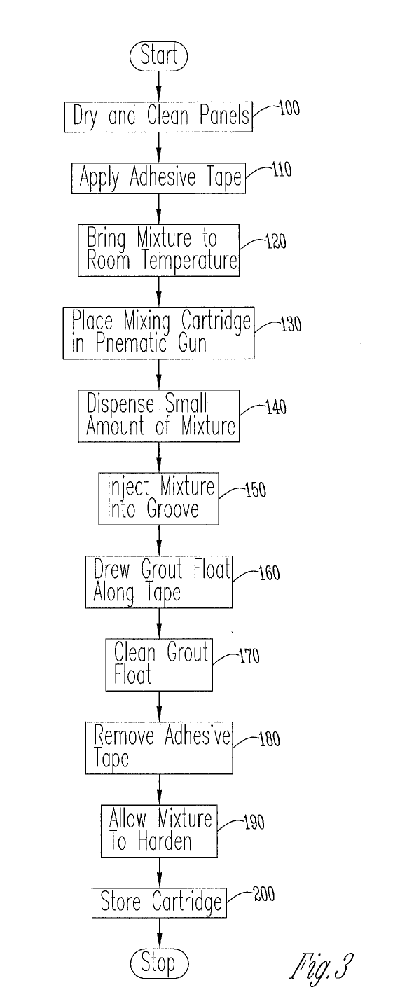

### DETAILED DESCRIPTION OF THE PREFERRED EMBODIMENT

Referring to the Figures, a method of filling and sealing a joint between panels utilizes a sealed container or cartridge 12 having a mixture 14 used in conjunction with pneumatic cartridge gun 16. While the method is used with a variety of joints, preferably, by example only, the method is used in jointless cold storage rooms as a joint filler for glass-fiber reinforced plastic panels manufactured by GFK Paneelen and also for use as a filler for the GFK Installation System.

To begin, at step 100, the surface of the panels 18 is dried and cleaned to remove any grease, dirt, dust, or coating. This can be done with a damp cloth or the like. In general, greater adhesive power is achieved on roughened or milled substrates. Also, preferred, is that the groove 20 has a sufficiently large volume to achieve even and correct through-hardening and rigidity (e.g. 4 mm wide×5 mm deep).

Next, at step 110, both sides of the groove 20 are covered with adhesive tape 22 that act as protective strips used to remove excess filler mixture 14 after the joint has been sealed. The mixture 14 in cartridge 12 comprises a first part 24 and a second part 26. The first part 24 includes at least 10% to 25% calcium carbonate, 1% to 2.5% of alkylated aromatic hydrocarbon, and Dimethylbis [(1-oxoneodecyl) oxy] stannan of less than or equal to 1%. The second part 26 includes 50% to 100% of Hexamethylen-1, 6-diisocyanat Homopolymer, 2.5% to 10% of calcium carbonate, less than or equal to 1% Bis (trimethoxysilyloropyl) amin, and less than or equal to 1% of hexamethylene-di-isocyanate.

The cartridge 12 containing mixture 14 is preferably brought to room temperature (approx. 18-23° C.) at step 120 in order to ensure easy application and full hardening. Heat accelerates hardening while cold delays hardening. At step 130, the cartridge 12 is placed on an upper side of a pneumatic cartridge 28, attached with a fastener 30 and inserted within the pneumatic cartridge gun.

To fill groove 20, at step 140 a small amount of mixture 14 is dispensed from gun 16, and discarded. Preferably about 10 cm of mixture is dispensed which is about the length of cartridges 12 and contains approximately 15 to 20 grams. By dispensing this small amount you ensure that both the first part 24 and the second part 26 are thoroughly mixed. Step 140 is repeated every time the cartridge 12 is changed. This happens whenever the cartridge 12 is empty or if the ejection process is interrupted by more than five minutes.

Next, at step 150, a generous amount of mixture 14 is injected evenly into groove 20.

Once filled, at step 160 a grout float 30 is drawn along both adhesive tape 22. Preferably the grout float 30 is drawn in one flowing movement to achieve a better appearance. Water should not be used as a smoothing agent.

At step 170, a cloth is used to remove excess mixture 14 from the grout float 30 which collects during the grouting and smoothing process. Immediately after step 170 is completed, the adhesive tape 22 on both sides of the groove 20 is removed at step 180 and the mixture is allowed to harden at step 190. When large areas are treated or if temperature differences are high tension cracks may appear. These cracks are not a defect but permit the system to release tension.

Because of the influence of temperature, the processing time for hardening step 190 can vary widely. Both the ambient temperature and the mixture 14 temperature affect processing time. Also, the dimensions of the cross section of the groove 20 also influence the reaction time of the first part 24 and second part 26 of the mixture 14 where a larger cross section increases the speed of the reaction.

As examples, using standard groove dimensions, the processing times are generally as shown in the table below:

| Temp. of Mixture | 16° C. | | 24° C. | | 27° C. | |
|---|---|---|---|---|---|---|
| Mixture Smoothable Up To | 13 | min. | 6 | min. | 5 | min. |
| Mixture Firm After | 31 | min. | 14 | min. | 9 | min. |
| Mixture Touch Dry After | 24 | hr. | 5 | hr. | 4 | hr. |

When completed, at step 200, cartridge 12 is left on cartridge 28 during storage and preferably stored at room temperature (approx. 18-25° C.). A new cartridge 12 is added when re-used and the opening of the cartridge is cleaned before use.

Thus a method of filling and sealing a joint has been disclosed that at the very least meets all the stated objectives.

What is claimed is:

1. A method of filling and sealing a joint, comprising the steps of:
placing a cartridge containing a joint filling mixture in a pneumatic gun;
dispensing a small amount of the joint filling mixture to ensure the mixture is mixed;
injecting a groove with the joint filling mixture;
smoothing the injected mixture within the groove; and
allowing the injected mixture to harden.

2. The method of claim 1 further comprising the step of cleaning and drying panels with the groove.

3. The method of claim 1 further comprising the step of applying adhesive tape to panels on each side of the groove.

4. The step of claim 3 further comprising the step of removing the adhesive tape from the panels.

5. The method of claim 1 wherein the mixture contains a first part and a second part.

6. The method of claim 5 wherein the first part includes at least 10% to 25% calcium carbonate, 1% to 2.5% alkylated aromatic hydrocarbon, and less than or equal to 1% Dimethybisstannan.

7. The method of claim 5 wherein the second part includes 50% to 100% of Hexamehylen-1, 6-diisocyanat Homopolymer, 2.5% to 10% calcium carbonate, less than or equal to 1% Bisamin, and less than or equal to 1% hexamethylene-di-isocyanate.
